(19) United States
(12) Patent Application Publication
(10) Pub. No.: US 2015/0083035 A1
(43) Pub. Date: Mar. 26, 2015

(54) VEHICLE SPEEDOMETER AND RELATED METHOD

(71) Applicant: Jaguar Land Rover Limited, Whitley Coventry Warwickshire (GB)

(72) Inventors: Sebastian Paszkowicz, West Midlands (GB); David Smith, Warwick (GB); Keith Talbot, Rugby (GB)

(21) Appl. No.: 14/387,490

(22) PCT Filed: Mar. 20, 2013
(86) PCT No.: PCT/EP2013/055789

§ 371 Date: Sep. 23, 2014

(30) Foreign Application Priority Data
Mar. 23, 2012 (GB) 1205161.1

(51) Int. Cl. G01P 1/11

(52) U.S. Cl. CPC G01P 1/11
USPC 116/62.3

(57) ABSTRACT

The present invention relate to a method of rendering speed limit data on a vehicle speedometer (1). The vehicle speedometer (1) has a scale (3) and an indicator (5) for indicating the instantaneous speed of the vehicle. A set of speed limit data is received indicating an effective speed limit. A symbol (15) indicating the speed limit is displayed on the scale (3). The symbol (15) is positioned adjacent to a graduation mark (7) corresponding to the effective speed limit. The symbol (15) represents the road sign providing notification of the effective speed limit. The invention also relates a vehicle speedometer (1). Aspects of the Invention also relate to a computer system and a vehicle.

### TECHNICAL FIELD

The present invention relates to a method of rendering speed limit data on a vehicle speedometer. The invention also relates to a vehicle speedometer. Further aspects of the invention relate to a vehicle and a computer system.

### BACKGROUND OF THE INVENTION

It is known from DE 102007004453 A1 to render a vehicle speedometer on a graphical Display. A camera and image processing device are provided to monitor road signs to determine a maximum permissible speed. A section of a speedometer ring is coloured red to indicate the maximum permissible speed determined by the image processing device. Uncertainty in the determined maximum permissible speed, for example resulting from two different outputs from the image processing device, is indicated colouring an intermediary section of the speedometer ring orange. The section of the speedometer ring below the determined permissible speed is coloured green.

It is against this background that the present invention has been conceived. Embodiments of the invention may provide a method, a system, a vehicle or a computer program which improves over the prior art arrangements. Other aims and advantages of the invention will become apparent from the following description, claims and drawing.

### SUMMARY OF THE INVENTION

Aspects of the invention provide a method, a system, a vehicle, or a computer system as claimed in the appended claims.

In a further aspect of the present invention for which protection is sought there is provided a method of rendering speed limit data on a vehicle speedometer, the vehicle speedometer having a scale and an indicator for indicating the instantaneous speed of the vehicle; the method comprising:

receiving speed limit data indicating an effective speed limit; and

displaying a symbol indicating said speed limit at a position corresponding to and/or adjacent to a graduation mark on the scale corresponding to the effective speed limit;

wherein the displayed symbol provides a graphical representation of the traffic sign providing notification of the effective speed limit.

By displaying the symbol adjacent to the effective speed limit on the scale, the driver can determine both the vehicle speed and the effective speed limit by looking in a single area. The positioning of the symbol on the scale is intuitive for the driver and can help to facilitate vehicle control. Indeed, since the information is depicted together, the driver can more readily manage vehicle speed in relation to the effective speed limit. The displayed symbol represents the road sign providing notification of the effective speed limit. Thus, the symbol at least substantially matches the appearance of the traffic sign providing notification of the effective speed limit.

By “at a position corresponding to” is meant, without limitation, that the symbol indicating the speed limit may be displayed at a fixed position relative to the graduation mark on the scale corresponding to the effective speed limit. For example, the symbol may be displayed in radial alignment with the corresponding graduation mark, either inwardly or outwardly thereof.

A plurality of said graduation marks is provided on the scale. The scale could be linear with said graduation marks provided along a longitudinal axis. Alternatively, the scale can be circular. The graduation marks can be provided in a circular arrangement around the scale. The symbol can be displayed along a radius of the dial coincident with the graduation mark corresponding to the effective speed limit. The symbol can be radially offset from the graduation mark. The symbol can be displayed inside or outside the scale.

The symbol can be a discrete element, for example comprising an image, letters or numbers. The symbol provides a graphical representation of the traffic sign providing notification of the effective speed limit. The displayed symbol can comprise a numerical indication of the effective speed limit. The numerical indication of the effective speed limit can be superimposed over a corresponding numerical marking on the scale. Thus, the symbol representing the effective speed limit is integrated into the scale. The symbol can consist of a circular device having numerical markings for indicating the effective speed limit. The method could comprise modifying the appearance of the numerical marking on the scale to represent the traffic sign providing notification of the effective speed limit. For example, a circle could be displayed around the numerical marking to represent a speed limit traffic sign according to the Vienna Convention on road signs.

The symbol can be displayed continuously when said speed limit data is available. Alternatively, the symbol can be displayed when the vehicle speed approaches or exceeds the effective speed limit.

The speed limit data could come from a database, for example coupled to a satellite navigation system. Alternatively, or in addition, the method can comprise recognising a traffic sign to determine the effective speed limit. A traffic sign recognition system can be operated to generate said speed limit data. A confidence level can be determined to estimate the likelihood of the traffic sign having been recognised correctly. The appearance of the symbol can be altered to represent the confidence level in the received speed limit data. For example, the symbol can be shown in black and white and/or partially transparent to show decreasing confidence levels. Thresholds could be defined for discrete confidence levels.

The method could include the step of controlling the speed of the vehicle based on the speed limit data. For example, an intelligent speed adaptation (ISA) system could be provided. The vehicle speedometer can be displayed on a graphical display device, such as a liquid crystal display. The scale could travel relative to a fixed indicator. Alternatively, the indicator can travel relative to a fixed scale.

As outlined above, the symbol indicating the effective speed limit can be radially offset from the corresponding graduation mark on the dial. The indicator can extend radially and rotate about a virtual axis coincident with a centre of a circular dial. The indicator can thereby emphasise the relationship between the effective speed limit and the current vehicle speed. When the vehicle speed approaches the effective speed limit, the indicator aligns with the symbol representing the effective speed limit.

According to a further aspect of the present invention there is provided a method of rendering threshold data on a gauge, the gauge having a scale and an indicator; the method comprising:

receiving threshold data relating to a defined threshold; and

displaying a symbol representing said threshold data adjacent to a graduation mark on the scale corresponding to said defined threshold.

The defined threshold can be movable based on one or more operating parameters. The scale can remain fixed while said defined threshold is modified. For example, if the gauge is a tachometer the scale can show fixed graduation marks representing revolutions per minute (rpm) and the defined threshold can display a transmission shift point. The shift point could change depending on an engaged driving mode, for example sport or eco driving modes. The indicator can be a needle or other suitable marker.

According to a further aspect of the present invention there is provided a method of rendering traffic sign data within a dial, the dial comprising a graduated scale and an indicator for indicating a vehicle operating parameter; the method comprising:

receiving traffic sign data; and

displaying a symbol corresponding to said traffic sign data;

wherein the graduated scale is arranged to demarcate a region and said symbol is displayed within said region. The dial can be a speedometer for displaying the vehicle speed. Alternatively, the dial can be a tachometer for indicating engine speed (for example revolutions per minute).

The graduated scale can define at least part of a circle. The indicator can comprise a needle rotatable about a centre of the circle. The graduated scale can demarcate a generally circular region.

The traffic sign data could indicate a traffic rule or notification, for example no overtaking; give way; or stop. The displayed symbol can be configured graphically to represent the corresponding traffic sign.

In a still further aspect, the invention relates to a computer system comprising: programmable circuitry; and software encoded on at least one computer-readable medium to program the programmable circuitry to implement the method described herein.

According to a further aspect of the present invention there is provided a vehicle speedometer configured to render speed limit data, the vehicle speedometer comprising:

a scale and an indicator for indicating the instantaneous speed of the vehicle;

a control module configured to receive speed limit data indicating an affective speed limit; and

a display device configured to display a symbol indicating said effective speed limit adjacent to a graduation mark on the scale corresponding to the effective speed limit;

wherein the symbol provides a graphical representation of the traffic sign providing notification of the effective speed limit.

The scale can be arranged in a circular configuration. The symbol can be displayed along a radius of the scale. The symbol can be radially offset from the graduation mark corresponding to the effective speed limit. The symbol can be displayed radially inwardly or outwardly of said graduation mark.

The display device can be configured to alter the appearance of said symbol to represent a confidence level in the received speed limit data. For example, the shape, colour or transparency of the symbol could be changed to represent different confidence levels.

The symbol can comprise a numerical indication of the effective speed limit. The numerical Indication of the effective speed limit can be superimposed over a corresponding numerical marking on the scale. The numerical indication can thereby replace the corresponding numerical marking on the scale. Alternatively, the display device can be configured to modify the appearance of a numerical marking on the scale to represent the traffic sign providing notification of the effective speed limit. For example, a circular ring could be displayed around the numerical marking on the scale to represent a speed limit traffic sign according to the Vienna Convention on road signs.

According to a still further aspect of the present invention there is provided a dial for displaying a vehicle operating parameter, the dial comprising:

a graduated scale and an indicator for indicating the vehicle operating parameter;

a control module configured to receive traffic sign data; and

a display device configured to display a symbol indicating said traffic sign data;

wherein the graduated scale demarcates a region of said dial and the symbol is displayed within said region. The dial can be a speedometer for displaying the vehicle speed. Alternatively, the dial can be a tachometer for indicating engine speed (for example revolutions per minute).

The graduated scale can define at least part of a rectangle or other polygon. Alternatively, the graduated scale can define at least part of a circle. The indicator can comprise a needle rotatable about a centre of the circle. The graduated scale can, for example, demarcate a generally circular region.

The traffic sign data could indicate a traffic rule or notification, for example no overtaking; give way; or stop. The displayed symbol can be configured graphically to represent the corresponding traffic sign.

In a further aspect, the present invention relates to a vehicle comprising a vehicle speedometer as described herein.

In a still further aspect the present invention relates to a gauge configured to render threshold data, the gauge comprising:

a scale and an indicator;

a control module configured to receive threshold data indicating a defined threshold; and

a display device configured to display a symbol indicating said defined threshold adjacent to a graduation mark on the scale corresponding to said defined threshold.

The display device can be a display screen, such as a liquid crystal display. The scale and indicator can also be displayed on said display device.

The method(s) described herein can be machine-implemented. The method described herein can be implemented on a computational device comprising one or more processors: such as an electronic microprocessor. The processor(s) can be configured to perform computational instructions stored in memory or in a storage device. The device described herein can comprise one or more processors configured to perform computational instructions.

Within the scope of this application it is expressly intended that the various aspects, embodiments, examples and alternatives, and in particular the individual features thereof, set out in the preceding paragraphs, in the claims and/or in the following description and drawings, may be taken independently or in any combination thereof. For example, features described in connection with one embodiment are applicable to all embodiments, unless such features are incompatible.

### BRIEF DESCRIPTION OF THE DRAWINGS

An embodiment of the present invention will now be described, by way of example only, with reference to the accompanying figures, in which;

FIGS. 1A-1H show a vehicle speedometer with a road recognition system in accordance with an embodiment of the present invention;

FIGS. 2A-2C show the vehicle speedometer in accordance with an embodiment of the present invention displaying different confidence levels in the received speed limit data;

FIG. 3 shows the vehicle speedometer in accordance with an embodiment of the present invention displaying additional road sign information; and

FIGS. 4A and 4B show a modified arrangement of the vehicle speedometer in accordance with the present invention.

### DETAILED DESCRIPTION OF AN EMBODIMENT

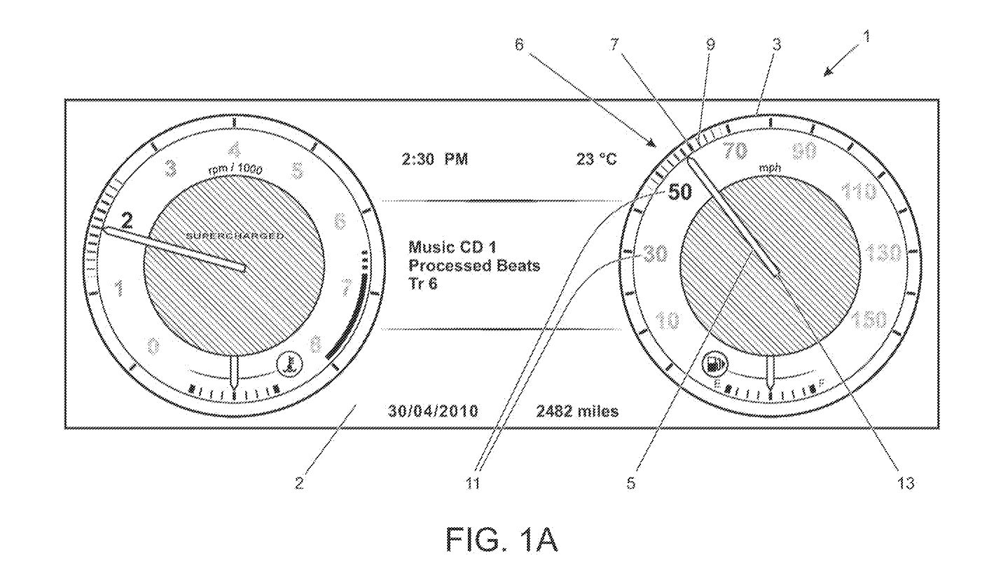

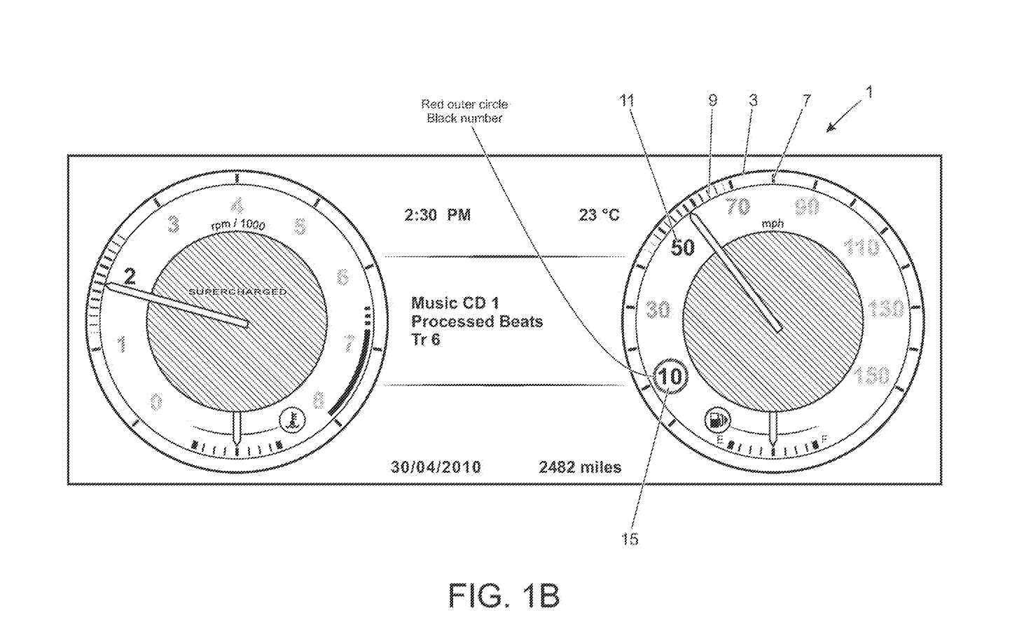

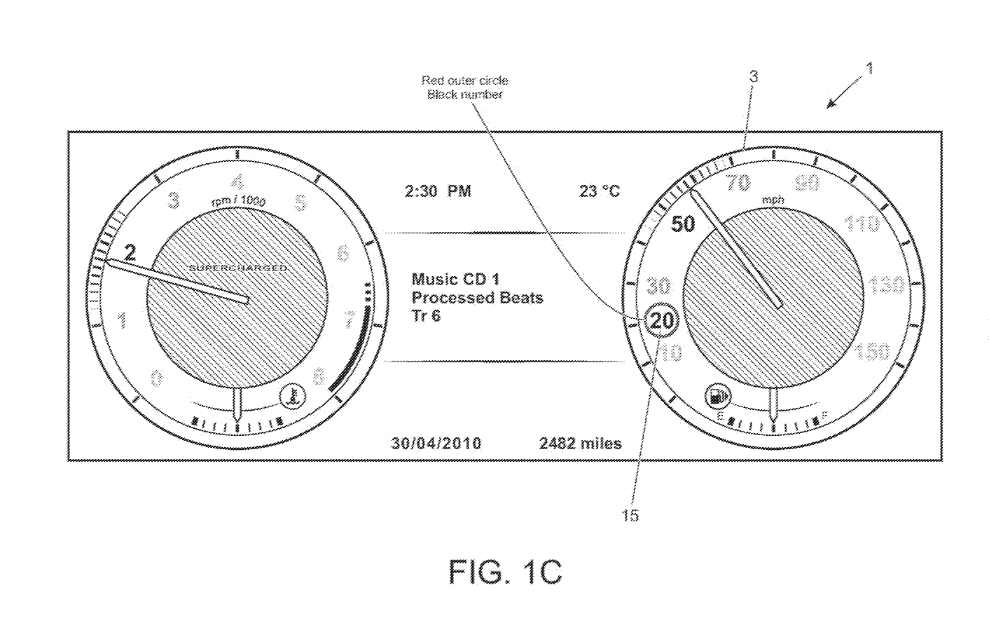

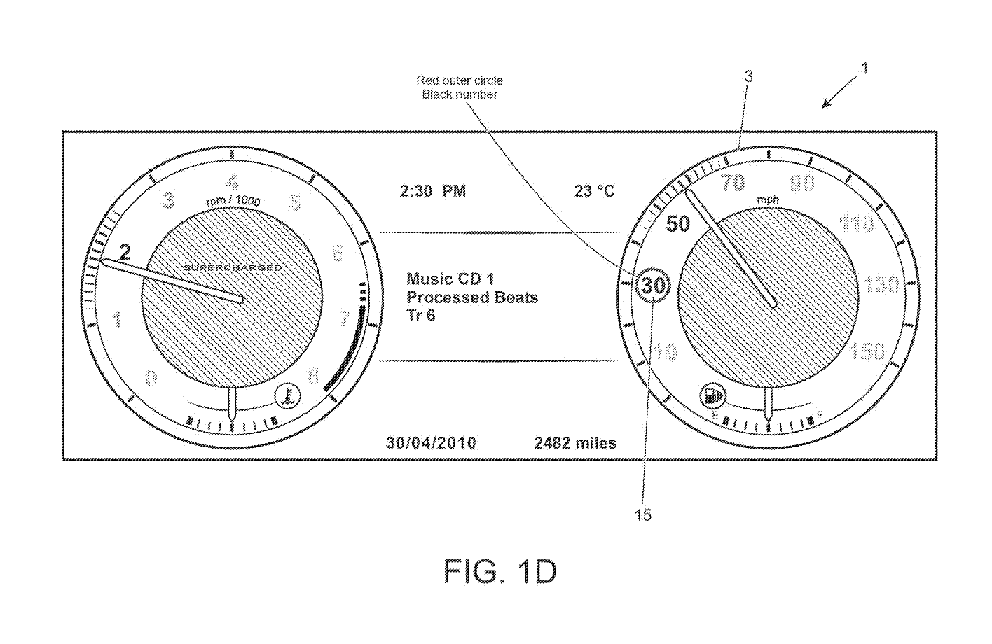

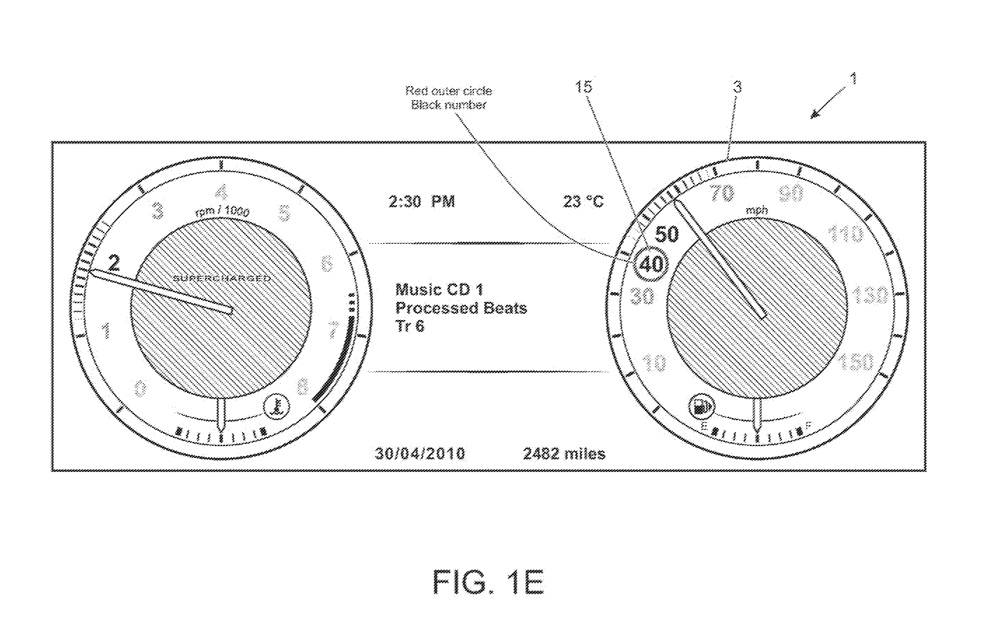

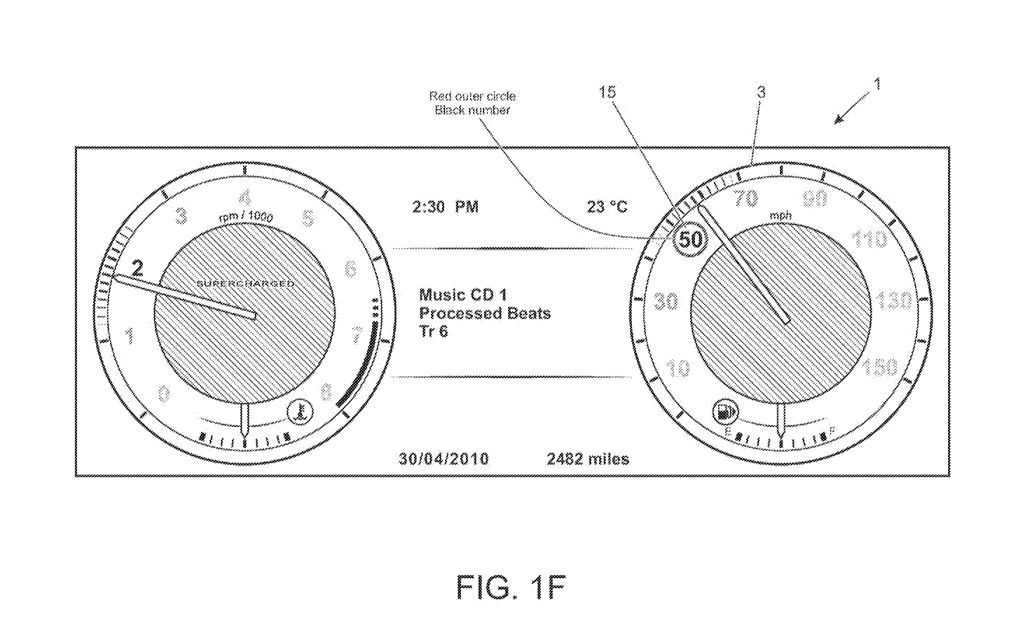

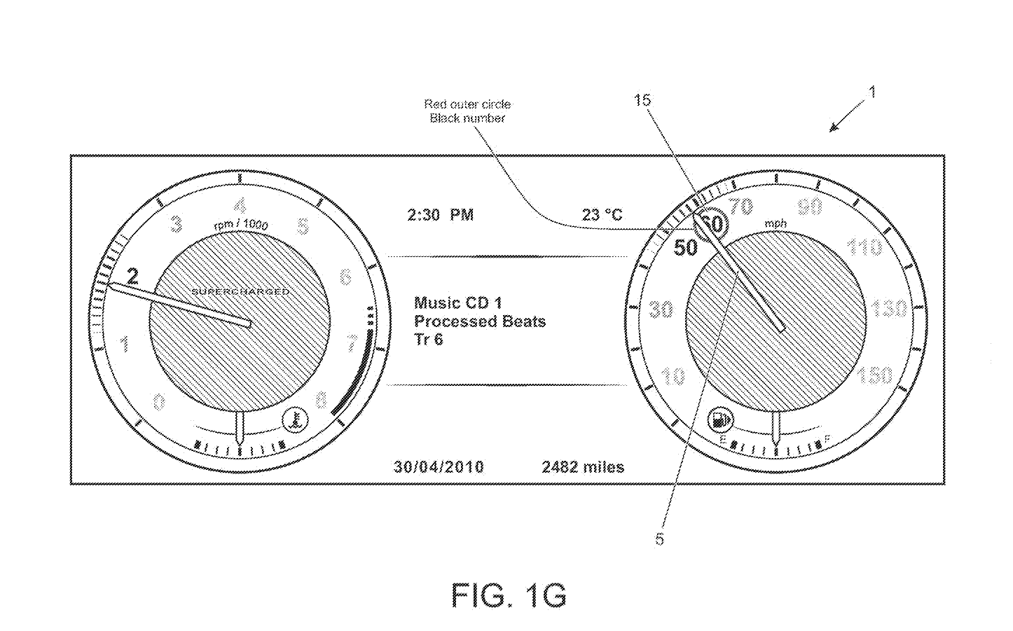

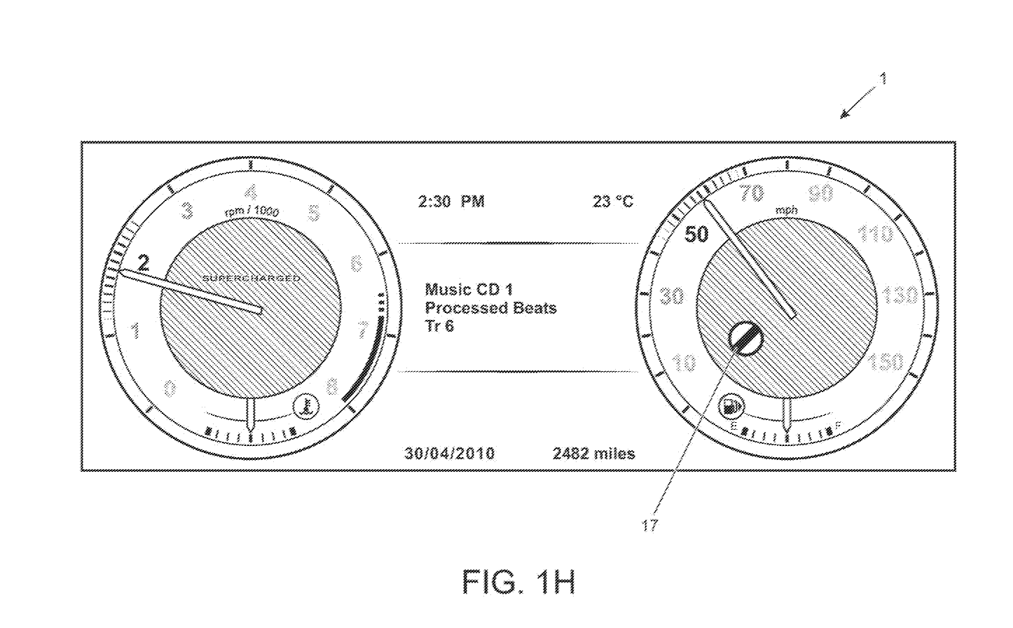

A speedometer 1 for showing the instantaneous speed of a motor vehicle (not shown) in accordance with the present invention is shown in FIG. 1. The speedometer 1 is configured to display speed limit data, including the effective speed limit, in a format which can readily be interpreted by the driver. The speedometer 1 is illustrated showing vehicle speed in miles per hour (mph), but it can be changed to kilometres per hour (kph).

The speedometer 1 is displayed on a digital display 2 located in an instrument cluster of the vehicle. The speedometer 1 is displayed as a circular dial 3 and a needle 5. The dial 3 defines a graduated scale 6 comprising major graduation marks 7 and minor graduation marks 9 which represent speed increments of 10 mph and 2 mph respectively. The major and minor graduation marks 7, 9 extend radially. A numerical sequence 11 increasing in increments of 10 mph is displayed on the dial 3 adjacent to and radially inset from the corresponding major graduation marks 7. In the present embodiment, the minor graduation marks 9 are only displayed proximal the needle 5 in a range ±10 mph of the current vehicle speed. Similarly, the numerical sequence 11 is only displayed for the two (2) major graduation marks above and below the needle 5 (corresponding to a speed range of 40 mph).

The speedometer 1 is controlled by a digital controller in response to a speed signal transmitted over the vehicle controller area network (CAN) bus. In use, the needle 5 rotates about a virtual axis 13 (coincident with the centre of the dial 3) to indicate the current vehicle speed by pointing at the appropriate major or minor graduation marks 7, 9 on the dial 3.

A traffic sign recognition system is provided in the vehicle to recognise traffic signs. The traffic sign recognition system comprises a forward facing camera or radar and an image processor for analysing image data to recognise traffic signs. Of particular relevance to the present invention, the traffic sign recognition system can identify traffic signs specifying the speed limit (i.e. the maximum permitted traffic speed) and determine the applicable speed limit. A road map navigation system can optionally also be coupled to the traffic sign recognition system to provide additional data. The traffic sign recognition system outputs a speed limit signal to the vehicle CAN bus to indicate the effective speed limit.

The speedometer controller displays a speed limit symbol 15 based on the speed limit signal output to the vehicle CAN bus. The speed limit symbol 15 is displayed on the dial 3 in a form representative of the detected speed limit traffic sign. By way of example, the speed limit symbol 15 is illustrated in the Figures as a red ring encircling the speed limit shown in black numbers which is the format of speed limit traffic signs according to the Vienna Convention on road signs. The speed limit units (i.e. mph or kph) which are displayed on the road sign can be omitted from the speed limit symbol 15 as this defaults to the units displayed on the vehicle speedometer 1. The speed limit symbol 15 is displayed on the dial 3 radially inset from the major graduation mark 7 for the corresponding speed. In the present embodiment, the speed limit symbol 15 overlies the numbers 11 indicating the vehicle speed. To avoid obscuring a portion of the needle 5, the speed limit symbol 15 is displayed behind the needle 5.

The operation of the vehicle speedometer 1 will now be described with reference to FIGS. 1A-1H. As illustrated in FIG. 1A, the vehicle speedometer 1 corresponds closely to the conventional speedometer 101 when there is no available traffic sign information. Upon Identification of a speed limit, the speedometer controller displays the speed limit symbol adjacent to the number 11 indicative of that vehicle speed. A detected speed limit of 10 mph will prompt the speedometer controller to display a speed limit symbol 15 comprising the number “10” radially inset from the major graduation mark 7 corresponding to a vehicle speed of 10 mph, as illustrated in FIG. 1B. Similarly, a detected speed limit of 20 mph prompts the speedometer to display a speed limit symbol 15 comprising the number “20” radially inset from the major graduation mark 7 corresponding to a vehicle speed of 20 mph, as illustrated in FIG. 1C. This process is repeated for detected speed limits of 30 mph, 40 mph, 50 mph and 60 mph as illustrated in FIGS. 1D-1G respectively,

If the traffic sign recognition system identifies a sign indicating that the national speed limit applies (represented by a black ring and single strike through on a white background under the Vienna Convention on road signs), the speed limit symbol 15 is removed from the dial 3. A second traffic sign symbol 17 representing the national speed limit sign is displayed in an inset position, as shown in FIG. 1H.

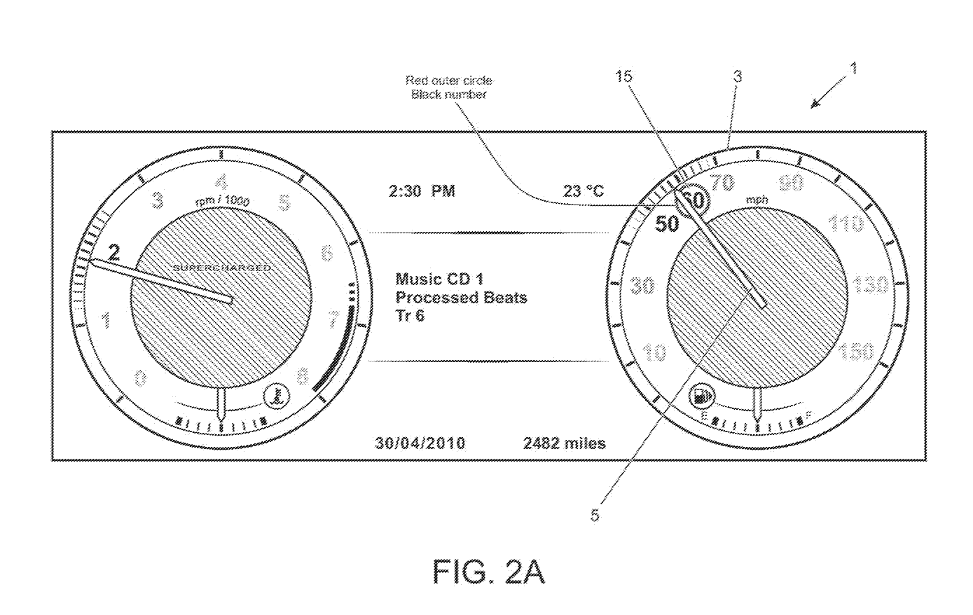

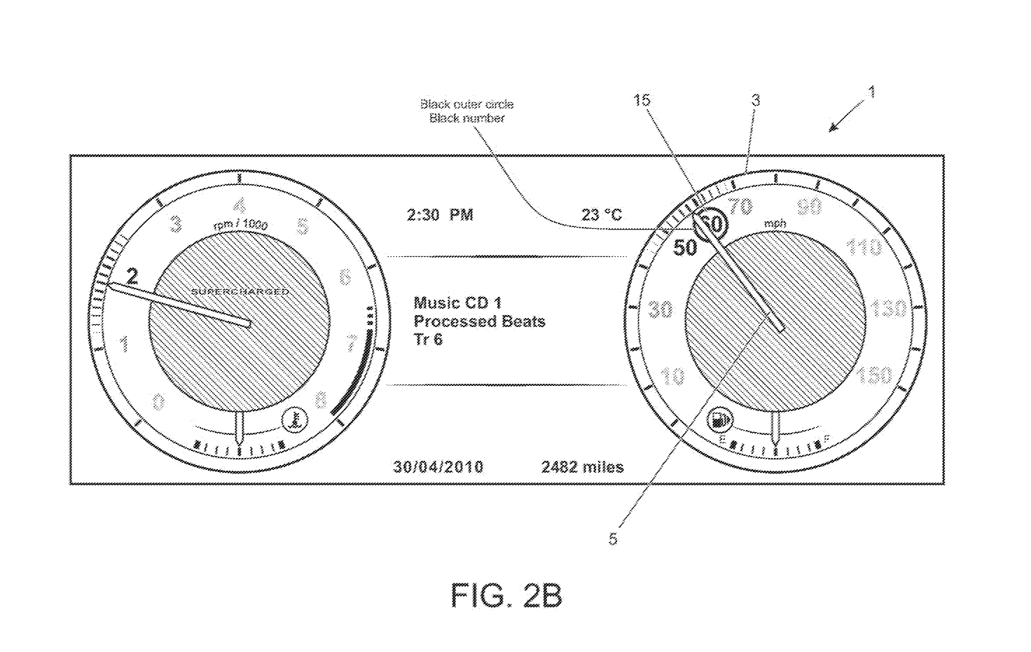

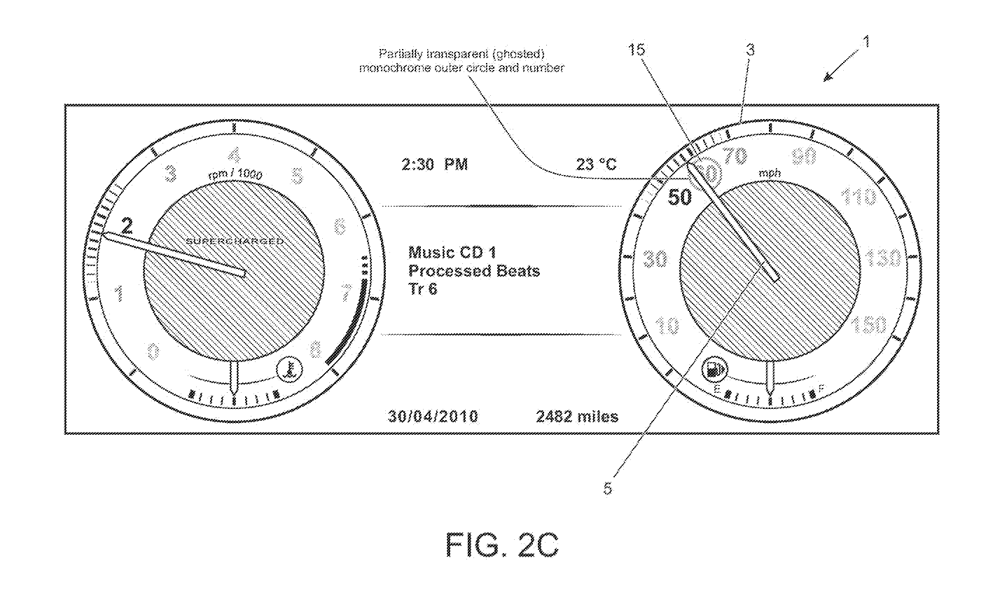

The traffic sign recognition system may net be completely confident that the speed limit has been identified correctly, for example due to inclement weather or if the traffic sign is partially obscured. The traffic sign recognition system can optionally also estimate the likelihood of the speed limit having been identified correctly. A confidence indicator signal can be output from the traffic sign recognition system to the vehicle CAN bus. By way of example, the confidence indicator signal could have three thresholds representative of a HIGH, MEDIUM or LOW level of confidence. If the confidence indicator signal shows a HIGH confidence level, the speed limit symbol 15 is displayed in colour (in the present embodiment comprising a red outer circle) as a solid image, as shown in FIG. 2A. If the confidence indicator signal shows a MEDIUM confidence level, the speed limit symbol 15 is displayed in black and white as a solid image, as shown in FIG. 2B. If, however, the confidence indicator signal shows a LOW confidence level, the speed limit symbol 15 is displayed as a black and white image which is partially transparent (a “ghost image”), as shown in FIG. 2C. The driver can decide how reliable the indicated speed limit is based on the appearance of the speed limit symbol 15. It is not essential that this confidence rating system is implemented in the speedometer 1.

The speed limit symbol 15 can be highlighted or emphasised as the vehicle speed approaches or exceeds the effective speed limit.

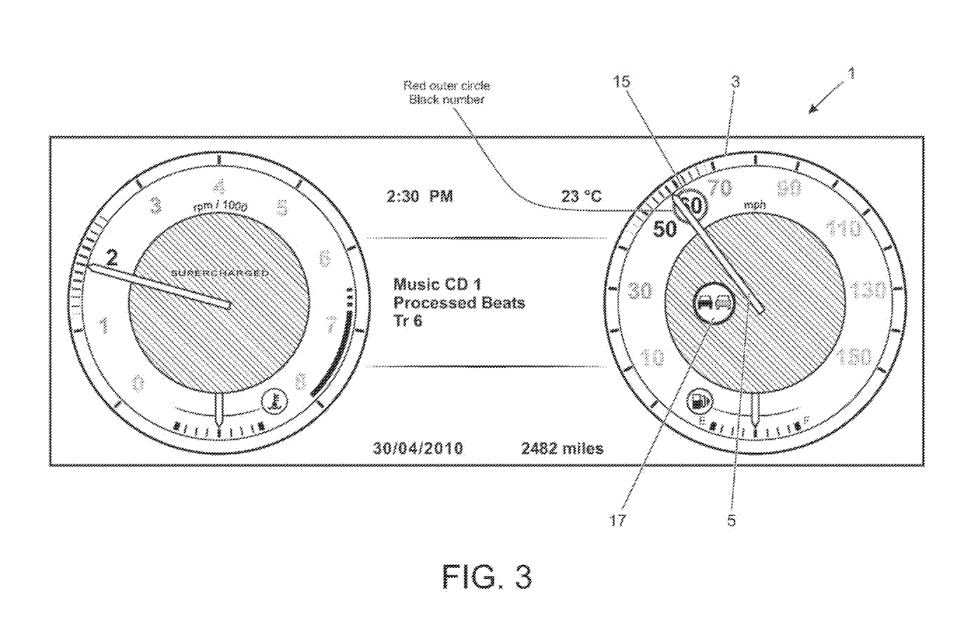

In addition to determining the speed limit, the traffic sign recognition system can recognise other traffic signs and display them on the speedometer 1. By way of example, in the scenario where traffic signs specify a speed limit of 60 mph and no overtaking, the speedometer 1 will display a speed limit symbol 15 comprising the number “60” and a second traffic sign symbol 17 representative of no overtaking, as illustrated in FIG. 3. The second traffic sign symbol 17 is displayed inside the circular dial 3 of the speedometer 1. Specifically, the second traffic sign symbol 17 is radially inset from the graduation marks 7, 9 and the numerical sequence 11. This inset display arrangement can allow additional information to be displayed without obfuscating the speedometer 1. The needle 5 is displayed in front of the second speed limit symbol 17 to ensure that the needle 5 remains visible along its length. The second traffic sign symbol 17 could represent other traffic signs, such as a traffic sign notifying of speed limit enforcement cameras.

The speedometer 1 according to the present invention displays a speed limit symbol 15 corresponding to an effective speed limit determined by the traffic sign recognition system. The position of the speed limit symbol 15 on the dial 3 is representative of the current speed limit. By displaying the speed limit symbol 15 adjacent to the major graduation marks 7, the driver can determine not only the current vehicle speed but also the effective speed limit. Moreover, by adjusting the appearance of the speed limit symbol 15 based on the confidence Indicator signal, the driver can determine the accuracy of the system.

It will be appreciated that various changes and modifications can be made to the embodiment described herein without departing from the spirit and scope of the present invention. For example, the graphical symbols (such as the speed limit symbol 15) can be modified to correspond to national traffic symbols, notably for North America which does not follow Vienna Convention road signs. The graphical symbols could default to the national registration of the vehicle.

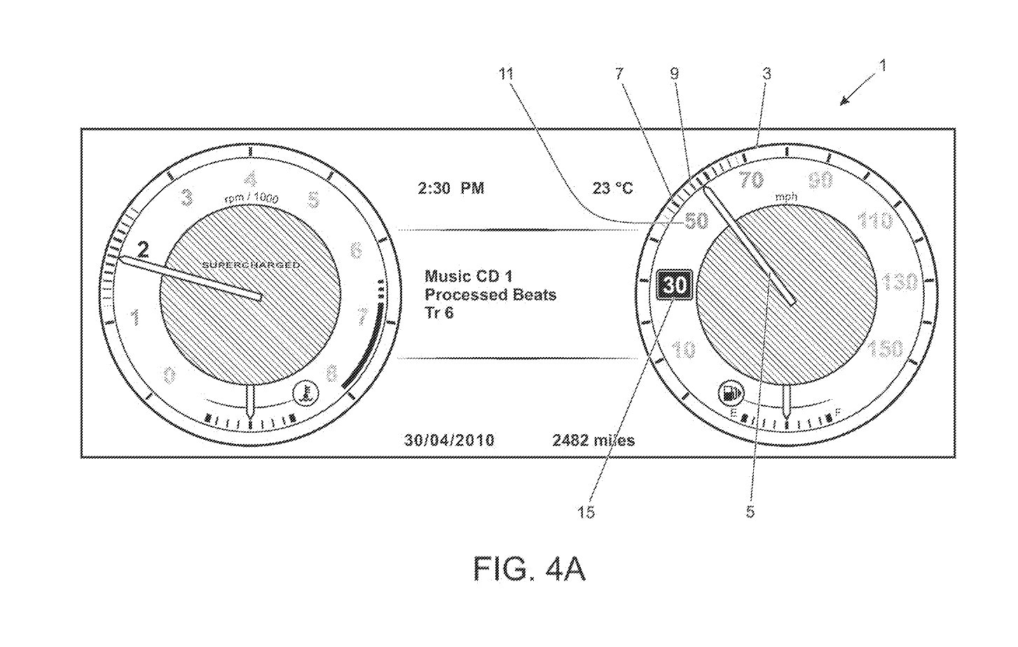

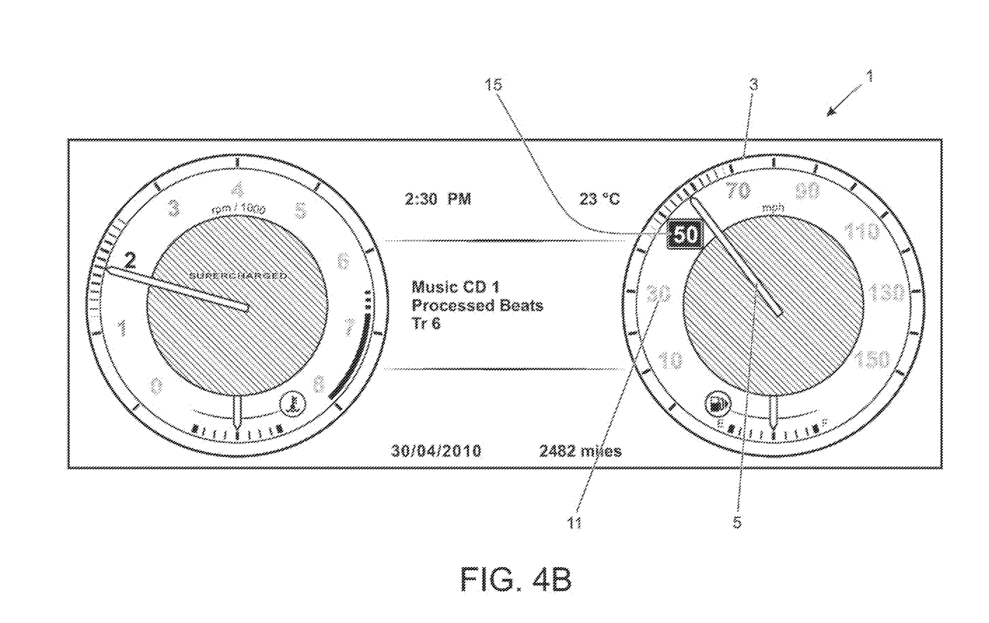

A modified arrangement of the speedometer 1 in accordance with the present invention is illustrated in FIGS. 4A and 4B. Like reference numerals are used to represent like features. The speedometer 1 has been modified to display a speed limit symbol 15 in a graphical form corresponding to the formal used in North America. In particular, the speed limit symbol 15 comprises a black rectangle having rounded corners and an inset white frame. The effective Speed limit is displayed by white numerical indicia. The arrangement in FIG. 4A represents an effective speed limit of 30 mph; and the arrangement in FIG. 4B represents an effective speed limit of 50 mph.

The speed limit symbol 15 is displayed on the dial 3 radially inset from the major graduation mark 7 for the corresponding speed. As with the embodiment illustrated in FIGS. 1 to 3; the speed limit symbol 15 is displayed to overlie (or replace) those numbers 11 on the dial 3 which indicate a vehicle speed corresponding to the effective speed limit. As shown in FIG. 4A, when the effective speed limit is 30 mph, the speed limit symbol 15 is displayed adjacent to the major graduation mark 7 indicating a vehicle speed of 30 mph in place of the numbers 11 (which otherwise provide the numerical display “30”). A corresponding approach is adopted when the effective speed limit is 50 mph, as shown in FIG. 4B. The needle 5 is displayed in front of the speed limit symbol 15 to ensure that the needle 5 is visible along its length.

The speed limit data has been described as being generated by a traffic sign recognition system. However, the speed limit data could be obtained from other sources, including an adaptive cruise control (ACC) system, an intelligent speed adaptation (ISA) system or a satellite navigation system.

It will be appreciated that various changes and modifications can be made to the speedometer 1 described herein without departing from the scope of the present invention. Further aspects of the present invention are set out in the following numbered paragraphs:

1. A method of rendering speed limit data on a vehicle speedometer, the vehicle speedometer having a scale and an indicator for indicating the instantaneous speed of the vehicle; the method comprising:

receiving speed limit data indicating an effective speed limit; and

displaying a symbol indicating said effective speed limit at a position corresponding to and/or adjacent to a graduation mark on the scale corresponding to the effective speed limit;

wherein the displayed symbol provides a graphical representation of the traffic sign providing notification of the effective speed limit.

2. A method as described in paragraph 1, wherein said scale is circular and said symbol is displayed along a radius of the scale coincident with the graduation mark corresponding to the effective speed limit.

3. A method as described in paragraph 1, wherein the displayed symbol comprises a numerical indication of the effective speed limit.

4. A method as described in paragraph 1, wherein the numerical indication of the effective speed limit is superimposed over a corresponding numerical marking on the scale.

5. A method as described in paragraph 1, wherein said symbol is displayed continuously when said road signal information is available.

6. A method as described in paragraph 1, wherein the appearance of said symbol is altered to represent a confidence level in the received speed limit data.

7. A method as described in paragraph 1, wherein the vehicle speedometer is displayed on a graphical display.

8. A method as described in paragraph 1 further comprising operating a traffic sign recognition system to generate said speed limit data.

9. A method of rendering traffic sign data within a dial, the dial comprising a graduated scale and an indicator for indicating a vehicle operating parameter; the method comprising:

receiving traffic sign data; and

displaying a symbol corresponding to said traffic sign data;

wherein the graduated scale is arranged to demarcate a region and said symbol is displayed within said demarcated region.

10. A computer system comprising: programmable circuitry; and software encoded on at

least one computer-readable medium to program the programmable circuitry to implement the method described in paragraph 1.

11. A vehicle speedometer configured to render speed limit data, the vehicle speedometer comprising:

a scale and an indicator for indicating the instantaneous speed of the vehicle;

a control module configured to receive speed limit data indicating an effective speed limit; and

a display device configured to display a symbol indicating said effective speed limit adjacent to a graduation mark on the scale corresponding to the effective speed limit

wherein the symbol provides a graphical representation of the traffic sign providing notification of the effective speed limit.

12. A vehicle speedometer as described in paragraph 11, wherein said scale is circular and said symbol is displayed radially offset from the graduation mark corresponding to the effective speed limit.

13. A vehicle speedometer as described in paragraph 11, wherein the display device is adapted to alter the appearance of said symbol to represent a confidence level in the received speed limit data.

14. A vehicle speedometer as described in paragraph 11, wherein the displayed symbol comprises a numerical indication of the effective speed limit.

15. A vehicle speedometer as described in paragraph 14, wherein the numerical indication of the effective speed limit is superimposed over a corresponding numerical marking on the scale.

16. A vehicle comprising a vehicle speedometer as described in paragraph 11.

17. A dial for displaying a vehicle operating parameter, the dial comprising:

a graduated scale and an indicator for indicating the vehicle operating parameter;

a control module configured to receive traffic sign data; and

a display device configured to display a symbol indicating said traffic sign data;

wherein the graduated scale demarcates a region of said dial and the symbol is displayed within said demarcated region.

1. A method of rendering speed limit data on a vehicle speedometer, the vehicle speedometer having a scale and an indicator for indicating the instantaneous speed of the vehicle; the method comprising:
receiving speed limit data indicating an effective speed limit; and
displaying a symbol indicating said effective speed limit at a position corresponding to and/or adjacent to a graduation mark on the scale corresponding to the effective speed limit;
wherein the displayed symbol provides a graphical representation of the traffic sign providing notification of the effective speed limit.

2. A method as claimed in claim 1, wherein said scale is circular and said symbol is displayed along a radius of the scale substantially angularly aligned or coincident with the graduation mark corresponding to the effective speed limit.

3. A method as claimed in claim 1, wherein the displayed symbol comprises a numerical indication of the effective speed limit.

4. A method as claimed in claim 1, wherein the numerical indication of the effective speed limit is superimposed over a corresponding numerical marking on the scale.

5. A method as claimed in claim 1, wherein said symbol is displayed continuously when said road signal information is available.

6. A method as claimed in claim 1, wherein the appearance of said symbol is altered to represent a confidence level in the received speed limit data.

7. A method as claimed in claim 1, wherein the vehicle speedometer is displayed on a graphical display.

8. A method as claimed in claim 1, further comprising the step of operating a traffic sign recognition system to generate said speed limit data.

9. A method of rendering traffic sign data within a dial, the dial comprising a graduated scale and an indicator for indicating a vehicle operating parameter; the method comprising:
receiving traffic sign data; and
displaying a symbol corresponding to said traffic sign data;
wherein the graduated scale is arranged to demarcate a region and said symbol is displayed within said demarcated region.

10. A computer system comprising: programmable circuitry; and software encoded on at least one computer-readable medium to program the programmable circuitry to implement the method claimed in claim 1.

11. A vehicle speedometer configured to render speed limit data, the vehicle speedometer comprising:
a scale and an indicator for indicating the instantaneous speed of the vehicle;
a control module configured to receive speed limit data indicating an effective speed limit; and
a display device configured to display a symbol indicating said effective speed limit adjacent to a graduation mark on the scale corresponding to the effective speed limit,
wherein the symbol provides a graphical representation of the traffic sign providing notification of the effective speed limit.

12. A vehicle speedometer as claimed in claim 11, wherein said scale is circular and said symbol is displayed radially offset from the graduation mark corresponding to the effective speed limit.

13. A vehicle speedometer as claimed in claim 11, wherein the display device is adapted to alter the appearance of said symbol to represent a confidence level in the received speed limit data.

14. A vehicle speedometer as claimed in claim 11, wherein the displayed symbol comprises a numerical indication of the effective speed limit.

15. A vehicle speedometer as claimed in claim 14, wherein the numerical indication of the effective speed limit is superimposed over a corresponding numerical marking on the scale.

16. A vehicle comprising a vehicle speedometer as claimed in claim 11.

17. A dial for displaying a vehicle operating parameter, and configured to implement the method of claim 9, the dial comprising:
a graduated scale and an indicator for indicating the vehicle operating parameter;
a control module configured to receive traffic sign data; and
a display device configured to display a symbol indicating said traffic sign data;
wherein the graduated scale demarcates a region of said dial and the symbol is displayed within said demarcated region.

18. A computer system comprising: programmable circuitry; and software encoded on at least one computer-readable medium to program the programmable circuitry to implement the method claimed in claim 9.
